(19) United States
(12) Patent Application Publication
(10) Pub. No.: US 2010/0182786 A1
(43) Pub. Date: Jul. 22, 2010

(54) HYBRID HID/LED REFLECTOR

(75) Inventor: William A. Hein, Manhattan Beach, CA (US)

Correspondence Address: FULWIDER PATTON LLP, HOWARD HUGHES CENTER, 6060 CENTER DRIVE, TENTH FLOOR, LOS ANGELES, CA, 90045, US

(73) Assignee: VISIONAIRE LIGHTING LLC, Rancho Dominguez, CA (US)

(21) Appl. No.: 12/357,235

(22) Filed: Jan. 21, 2009

(51) Int. Cl. F21V 7/00

(52) U.S. Cl. 362/240

(57) ABSTRACT

A lighting fixture having a first light source and a second light source contained within a single housing. In a first embodiment the first light source is an LED lighting source and the second light source is an HID lighting source within a common housing is disclosed. Each lighting source includes its own reflector assembly, and the reflector assemblies can be side by side. Alternatively, an induction lighting source can be substituted for the LED or HID light source. The lighting fixture is suited for outdoor lighting or indoor lighting, where each lighting source can operate independent of the other lighting source.

### BACKGROUND

Wide area lighting fixtures are commonly used for both indoor and outdoor applications. Indoor lighting such as those used in arenas, gymnasiums, aircraft hangers, and other large venues use wide area lighting. Outdoor lighting fixtures such as those used for street lighting, parking structures, and other exterior lighting applications are also widely used. These wide area fixtures typically involve a light source, such as a bulb, lamp, or other illumination source, a transformer for converting a power supply to the light's power requirements, and a reflector that cooperates with the light source to direct a majority of the illumination toward a particular area. When the fixtures are elevated and the reflectors are directed downward, an area such as an arena, a street or a parking lot can be illuminated by strategic placement of the fixtures in an array.

The types of wide area lighting fixtures vary depending upon the particular application and lighting requirements. High Intensity Discharge (“HID”) fixtures, for example, are one of the most prevalent outdoor lighting fixtures in use today. HID lamps typically include an arc tube within the lamp glass envelope that can be efficiently focused by a reflector systems to efficiently deliver the light where it is needed. HID fixtures utilize full cutoff non-glary reflector systems which cast the light a long distance from the fixture even though the light source is hidden and the fixture is pointing straight down. HID fixtures include metal halide, pulse start, high pressure sodium, and low pressure sodium light sources. HID lighting offers the benefits of lower costs, greater illumination, more economical to repair and replace, and higher efficiency as opposed to other light sources.

Metal Halide and Pulse Start lighting fixtures produce a white appearing light that is particularly prevalent in shopping center parking lots, car dealerships, outdoor sports venues, and other locations where it is desirable to have a very “white” light. Metal Halide and Pulse Start lamps produce approximately 90-110 lumens per watt and are considered very efficient, and have lamp life expectancies in the 12,000 to 18,000 hour range, approximately.

High pressure sodium lights are often used for street lighting and give off a gold light. High pressure sodium lamps have a longer lamp life than metal halide lights and are thus preferred by municipalities for street lighting. Also, the gold light output given off by high pressure sodium has a reduced glare, which is preferred in residential neighborhoods. High pressure sodium lamps are very efficient, producing about 125 lumens per watt on average and the lamp life expectancy is approximately 24,000-40,000 hours.

Low Pressure Sodium lamps are also used in outdoor applications, but they produce an orange light that is not pleasing to the eye. Low pressure sodium lights are even more efficient than high pressure sodium lights and can produce approximately 140-180 lumens per watt and have a lamp life expectancy of approximately 24,000 hours. Low pressure sodium lights also have the advantage that they are not as intrusive to astronomers because they can filter out the orange light and see the stars more clearly with their telescopes.

In addition to HID lighting sources, light emitting diodes (“LEDs”) are a newer candidate for an outdoor lighting source. The efficacy (lumens per watt) of LEDs has increased dramatically over the past five years and is expected to continue into the future. Presently LEDs are emitting approximately 65 lumens per watt out of a light fixture. LED lighting is very expensive at this point as well, so its use for outdoor lighting has been limited. However, the LED lights have the benefit of longer life expectancy and more favorable color rendition. For example, present LED lamps are rated at 50,000 hours or more, or twice the rating of low pressure sodium lights. Transformers for LED lights currently operate for at least five years. Also, LED lights are capable of emitting a light in the 6,000 Kelvin range, producing an extremely bright white light.

Another benefit of LED lighting is it can be controlled and adjusted to a far greater degree than most other lighting sources. This control can be used to manage energy saving, security enhancing, and diagnostic. For example, LED lamps have instant re-strike capability and can be dimmed to any percent of its full output. The LED lighting fixture can be coupled to a motion sensor and be off. When the motion sensor is triggered, the LED light can activated and instantly achieve full brightness. Another example of the controllability of LED lights is the capacity to daylight harvest. That is, an LED light fixture in the presence of ambient light will power up only to the preset lighting level requirement for the specified application while maximizing the ambient light, thereby resulting in large energy savings. Moreover, LED lighting fixtures can be programmed to increase their light levels gradually. For example, at sunset LED light fixtures can be programmed to illuminate at ten percent of its maximum output at 5:30 p.m., then twenty percent at 5:45 p.m., followed by an illumination level of fifty percent at 6:00 p.m., and one hundred percent at 6:30 p.m. The same process can be applied in reverse for sunrise. When this savings is applied each day to thousands of lighting fixtures, the energy savings can be very substantial.

LED lighting fixtures also can serve as security or safety lights, such as lights that flash if there is an impending dangerous event about to occur like a natural disaster (tornado, tsunami, etc.). In a street light situation, an LED light can be coupled to the 911 emergency system and the closest street light to a distress call can be programmed to flash, making it easier for an emergency response team such as paramedics and fireman to locate the 911 caller quickly. LED lights could also have links to key chains where a distressed person pushes a button on his or her key chain and the closest light in a parking lot might flash alerting security quickly to the location of the person and the problem.

LED lighting fixtures permit diagnostics that can report the exact energy usage of the fixture so that the operator knows how much electricity is being used and saved. Diagnostics can also report a failure and be used to predict failure, and LED lights can report their temperature.

Another aspect of outdoor lighting is the effect that white light has on the brain and its relation to sleep and sleep disorders. Studies have been performed that suggest white light prevents the production of melatonin within the brain. Melatonin production is a very important aspect of sleep and health. Lighting fixtures that emit white light for extended periods may be subjecting local residents to a risk of sleep disorder by preventing the production of melatonin.

Another aspect of outdoor lighting is its effect on astronomical observatories. Light pollution from outdoor lighting is the biggest obstacle to these observatories. Artificial lighting in the night sky diminishes the astronomer's ability to see faint objects and to record their spectra. Minimizing light sources near observatories is essential to such operations, and care must be taken to select the proper lighting. There is a strong preference in this application for low pressure sodium lamps, as these lamps have a nearly monochromatic spectrum. Light from these sources can be filtered out of astronomical images, and the wavelengths used for sodium lights are already somewhat compromised by the micrometeorites that deposit sodium into the upper atmosphere, where it glows at night. High color-temperature light sources are particularly damaging to astronomy, as they tend to emit a blue light. When the moon is down, the night sky is naturally dark in the blue part of the light spectrum, and contributions from these light sources make it difficult to isolate distant objects. Additionally, Rayleigh scattering, absorption and remission of light by air molecules, is strongly color dependent, and is more efficient with blue light as evident by the blue daytime sky which results from this phenomenon.

Yet another type of lighting is induction lighting. Induction lighting is similar to fluorescent lighting in that induction lighting uses the excitation of a contained gas or gases, that react to phosphors inside a lamp to produce white light. Induction lamps transmit their energy through a magnetic field as opposed to electrodes. Induction lamps are rated up to 100,000 hours and are typically used in street lighting, parking lot lighting, warehouse lighting, freezer lighting, and anywhere where there would be a requirement for light with a difficult or problematic access for maintenance. For instance a 100,000 hour lamp would be very useful externally at a nuclear power plant. Induction lighting are also used in cold temperature, because the lights can operate in temperatures as low as forty degrees below zero. The benefits of induction lighting are extended life expectancies (as much as 100,000 hour life, or 20 years), which can lead to tremendous maintenance savings. Induction lighting also yields high color rendering of up to 85 CRI, making the objects lit under induction lighting to appear very close to their true color. Induction lighting also offers a large range of color temperatures, ranging from 2700° Kelvin to 6500° Kelvin. A large range of wattages are available between 40 watts-400 watts, and induction lighting does not suffer from flickering or a strobe effect and no humming. Induction lighting is also very energy efficient and has an efficiency of greater than 85 lumens per watt. Induction has very high lumen maintenance over its entire life and instant on and instant restrike capability, i.e. there is virtually no warm up time. Dimming for induction is just becoming available, and induction lamps can be tied to motion sensors.

### SUMMARY OF THE INVENTION

The present invention addresses the shortcomings of the various lighting options currently available by disclosing a hybrid lighting fixture that combines both LED lighting with HID lighting in a single, dual illumination housing with separate reflectors for each type of lighting. The concept of the invention is to utilize both types of lighting in alternating fashion, optimizing the benefits of each specific light source. The dual or “hybrid” light fixture incorporates the benefits of both lighting sources within the same housing, which would enable outdoor lighting fixtures incorporating the invention to utilize white LED light up until a specific time of night, after which the lighting source would switch to utilize the HID source and its amber or monochromatic light. This allows pedestrians and drivers to experience enhanced viewing conditions under the white light when streets and parking lots are most populated. Later, when fewer people are out, the lights would change to amber and the observatories and star gazers and those that appreciate the darker skies could observe better. Moreover, with both light sources used alternatively in the same fixture for approximately half the time, the bulbs and transformers of each light source would last twice as long. This would result in components that last 10-14 years without maintenance instead of 5-7. The cost savings are substantial for municipalities that maintain thousands of light fixtures.

In addition, most existing traffic and crime liability laws are written around HID light levels. From a liability standpoint, a municipality with such regulations would run a risk of incurring liability by replacing HID lighting with LED lighting, since present LED lighting emits less light when metered. The present invention allows a hybrid light to operate an HID source during a required period such as late at night when many fatal accidents occur, and then utilize LED lighting at dusk or during times when the regulations are not in force.

The present invention also improves cost by incorporating two sources into a single housing, and doubling the life expectancy of the lighting fixture. In an alternative embodiment of the present invention, the LED or HID light source is replaced with an induction light source where both light sources are contained within the same fixture.

### BRIEF DESCRIPTION OF THE DRAWINGS

FIG. 1 is a front view of a first embodiment of the present invention;

FIG. 2 is an elevated perspective view of the first embodiment of FIG. 1;

FIG. 3 is a side cross-sectional view, rotated ninety degrees, of the first embodiment of FIG. 1; and

FIG. 4 is an elevated rear perspective view of the first embodiment of FIG. 1.

### DETAILED DESCRIPTION OF THE PREFERRED EMBODIMENTS

The present invention is directed to a lighting fixture having a single housing that houses an LED light source and a high intensity discharge (HID) light source. In a preferred embodiment, the LED and HID light sources have their own separate reflector assemblies incorporated and integrated into the single housing. The term HID light source as used herein refers to a metal halide, pulse start, high pressure sodium, low pressure sodium, and mercury vapor light source. When used in a common housing, and preferably in a side by side relationship, the two light sources can be utilized to extract the benefits of each individual light source while minimizing the shortcomings of each light source.

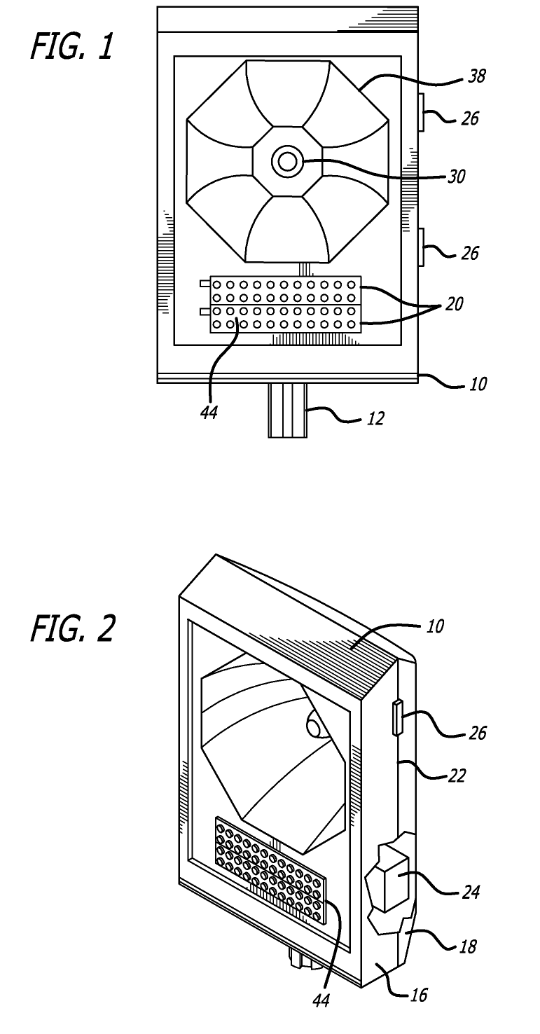

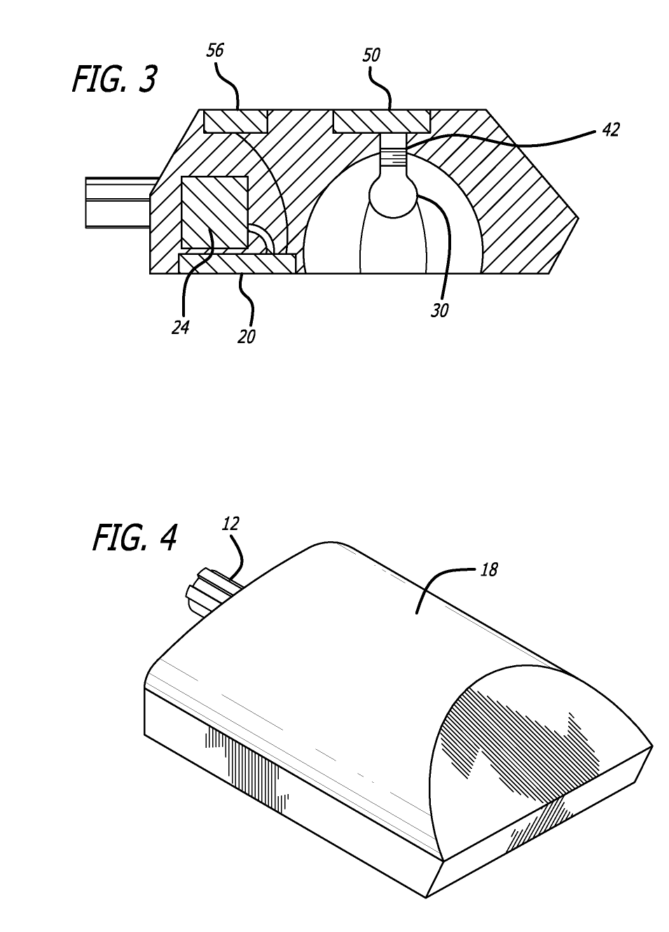

FIGS. 1-4 illustrate a first preferred embodiment of the present invention comprising a fixture housing 10 that includes a fixture stem 12 that adapts the fixture to a standard lighting pole or structure (not shown). The housing 10 can be made of sheet aluminum, steel, or sturdy corrosion resistant polymer and preferably includes a lens that covers the lighting elements, although the lens has been removed in the figures for clarity. The housing 10 may also have a hinged or latched system that allows access to the interior of the housing, such as a hinge 26 mounted on the juncture 22 between the front half 16 and the rear half 18 of the housing 10. The housing mounts two distinct lighting sources, an HID lighting source 30 and an LED lighting source 20.

The HID lighting source comprises an HID lamp such as a high pressure sodium lamp, a low pressure sodium lamp, a mercury vapor lamp, or another HID source. The HID source is mounted in a socket 42 and is surrounded by a reflector system 38 such as a parabolic or multi-facet reflector system to direct the HID light source in the desired direction. An HID transformer 50 converts the voltage from an exterior power supply to the proper voltage for the lighting fixture.

The LED light source 20 comprises an array of LED diodes 28, and the array has its own separate reflector 44 of metal or glass, and a separate heat sink (not shown) for preventing potentially damaging heat build-up near the LED. The LED light source 20 will have its own transformer 56 within the housing to control the power into the LED diode array. The LED lighting source may include its own lens, or a single lens may cover both the HID and LED lighting sources. Optionally, the LED source will be coupled to a controller 24 for regulating and performing diagnostic evaluation of the LED light source during operation. The controller 24 may be available from Unisonique Technologies Co., LTD. The housing will also typically include a gasket between the lens and the outer perimeter of the housing to preclude moisture, dirt, and impurities from entering the lighting fixture.

The housing 10 may be formed of sheet aluminum and welded into a unitary structure, or alternatively may be die or sand cast or molded into the desired shape. The HID and LED transformers 50,56 are mounted to the housing, and then the LED heat sink and the LED optics and diodes are affixed. The option controller 24 is then mounted, including any sensors or communication equipment that would allow the controller to receive information or instructions from a distant location and would allow information about the system to be relayed to a remote location. The HID reflector 38 is installed in the housing 10 with the socket 42, and the LED and HID lighting sources are incorporated into the fixture. The system is wired together, and the lens and seal are installed and the unit is tested for operation.

One advantage of the present invention is the capability of operating the white light LED lighting source 20 for one half of the night and then operate the HID lighting source 30 such as low pressure sodium or high pressure sodium for a second half of the night. This method has several benefits. For example, the economical benefit is potentially large as a result of sharing the operation between the two light sources. LED lamps are estimated to last 50,000 hours (10 years), and LED generators are estimated to last 25,000 hours (5 years). On the other hand, HPS (High Pressure Sodium HID) lamps are estimated to last 40,000 Hours (8 years). The Hybrid fixture of the present invention could save those tasked with the maintenance of such outdoor lighting fixtures substantial monetary outlays in labor costs since the hybrid fixture can go without replacement of the lamps or ballast for up to ten years. The costs of the replacement lams and ballasts are also realized by the present invention. The maintenance costs reduction also manifests itself in less transportation costs for workers to travel to the site for repairs, and fewer trucks or equipment will be necessary to maintain the system. Since the fixture could be used to operate each light source for only half the night, the components will last roughly twice as long as before, extending the life of the generators and transformers as well.

Astronomers don't like white LED light because they can not filter out the white light glow from their telescopes because the objects they are studying are white. Astronomers do have the ability to filter out amber light. The present invention allows a change to amber light at a selected hour at night during astronomical observation hours without hindering astronomical research and improving the view of the stars for all. During high traffic hours citizens can have white light which is easier to see, and later the fixture can switch to an dark-friendly light and the astronomer and star gazers can benefit from the change.

The present invention utilizes the benefits of LED lighting and HID lighting into a single housing lighting fixture that can alleviate the shortcomings of each lighting source and utilize the benefits of each lighting source. It is to be understood that the figures and descriptions herein are merely illustrative and not intended to be limiting as to the scope of the invention. For example, the present invention can be used for many applications not discussed herein, using wall mounts or ceiling mounts for indoor use. Therefore, when construing the scope of the invention, it is intended that the invention's scope be construed by the words of the claims below, using the ordinary and customary meaning of those words consistent with, but not limited by, the foregoing descriptions and figures.

I claim:

1. A dual lighting fixture comprising:
a housing having a first reflector system and a second reflector system;
an LED lighting source associated with said first reflector system; and
a high intensity discharge (HID) light source associated with said second reflector system.

2. The dual lighting fixture of claim 1 wherein the high intensity discharge light source comprises a low pressure sodium lamp.

3. The dual lighting fixture of claim 1 wherein the high intensity discharge light source comprises a high pressure sodium lamp.

4. The dual lighting fixture of claim 1 wherein the high intensity discharge light source comprises a mercury vapor lamp.

5. The dual lighting fixture of claim 1 wherein the first reflector system and the second reflector system are arranged side by side.

6. The dual lighting fixture of claim 1 further comprising a controller coupled to the LED lighting source for managing an output of the LED lighting source.

7. The dual lighting fixture of claim 1 further comprising an LED transformer and an HID transformer.

8. The dual lighting fixture of claim 1 wherein each lighting source operates independently of the other lighting source.

9. A dual lighting fixture comprising:
a housing having a first reflector system and a second reflector system;
an LED lighting source associated with said first reflector system; and
an induction light source associated with said second reflector system.

10. A dual lighting fixture comprising:
a housing having a first reflector system and a second reflector system;
an induction lighting source associated with said first reflector system; and
a high intensity discharge (HID) light source associated with said second reflector system.
